(19) United States
(12) Patent Application Publication
(10) Pub. No.: US 2019/0180397 A1
(43) Pub. Date: Jun. 13, 2019

(54) Class Timetable Adjustment System With Real-Time Feedback And Method Thereof

(71) Applicants: Inventec (Pudong) Technology Corporation, Shanghai (CN); Inventec Corporation, Taipei City (TW)

(72) Inventor: Guo-Hong Tu, Shanghai (CN)

(21) Appl. No.: 16/009,640

(22) Filed: Jun. 15, 2018

(30) Foreign Application Priority Data
Dec. 7, 2017 (CN) 201711288182.7

(51) Int. Cl. G06Q 50/20; G06Q 10/10

(52) U.S. Cl. CPC G06Q 50/205; G06Q 10/1095

(57) ABSTRACT

A class timetable adjustment system with real-time feedback and method thereof are disclosed. A heuristic algorithm and at least one schedule constraint are used to perform calculation to generate an initial class timetable, and a total score is calculated according to a score of the schedule constraint and whether the schedule constraint is satisfied, and a graphical interface including a plurality of block units is generated for displaying the initial class timetable. When one of the block units is dragged, the block unit not allowed to exchange is found, and the found block unit is set with a conflict flag and a conflict description. The system and the method can adjust the total score in real-time, and highlight the block unit with a prompt according to the conflict description, so that to improve the appropriateness and the convenience in scheduling class.

### CROSS-REFERENCE TO RELATED APPLICATION

This application claims the benefit of Chinese Patent Application No. 201711288182.7, filed Dec. 7, 2017.

### BACKGROUND OF THE INVENTION

### 1. Field of the Invention

The present disclosure generally relates to a class timetable adjustment system, more particularly to a class timetable adjustment system capable of prompting a class collision description and a total score, in real time, for reference of class scheduling operation, and a method thereof.

### 2. Description of the Related Art

In recent years, with the popularization and rapid development of digitalization, various digital applications are springing up, and a class scheduling system is one of the common digital applications.

In general, the class scheduling system is used to arrange classes in consideration of teaching times, teachers, classrooms, students, courses, and class scheduling rules, so as to generate a class timetable. However, when a user operates the conventional class scheduling system to adjust the classes, the conventional class scheduling system is unable to provide, in real time, a feedback message to prompt the user whether the class adjustment may cause class collision, and the conventional class scheduling system is also unable to prompt severity of the class collision to the user, for allowing the user to adjust the classes according to the feedback message; as a result, the user cannot know the class collision event until all class adjustments are completed, and the user must adjust the classes again and again, and it seriously reduces efficiency of scheduling classes. In addition, due to lack of comparison of the class timetables before adjustment and after adjustment, the user is hard to confirm whether the adjusted timetable is better than the timetable before adjustment; as a result, the user may have worse timetable after adjustment. Therefore, the conventional class scheduling system has the problems of poor appropriateness and poor convenience.

In order to solve above-mentioned problems, some manufacturers develop a class scheduling system capable of prompting whether collision between the two exchanged classes occurs, so that the user can adjust the classes according to the prompt. However, this system merely shows whether the exchanged courses collided with each other, and the user still needs to be tried for many times to know whether collision occurs in all courses. Furthermore, the system also does not prompt the severity of class collision, so the user may have worse class timetable after adjustment. Therefore, the system still does not effectively solve the problems of poor appropriateness and convenience.

Therefore, what is needed is to develop an improved technical solution to solve the conventional problem of poor suitability and convenience in class scheduling.

### SUMMARY OF THE INVENTION

In order to solve convention problem, the present invention is to provides a class timetable adjustment system with real-time feedback and a method thereof

According to an embodiment, the present invention provides a class timetable adjustment system with real-time feedback, and the system comprises a setting module, an initialization module, a calculation module, a display module, a dragging module, a processing module and a prompting module. The setting module is configured to set a plurality of class schedule constraints, and each class schedule constraint comprises a score. The initialization module is configured to perform calculation according to heuristic algorithm in consideration of the class schedule constraints, so as to generate an initial class timetable. The initial class timetable comprises class messages, and each class message comprises an identifier and an index. The calculation module is configured to check whether the class schedule constraints are satisfied, and when one of the plurality of class schedule constraints is satisfied, the calculation module accumulates the score of the class schedule constraint being satisfied, so as to generate the total score, and when one of the plurality of class schedule constraints is not satisfied, the calculation module subtracts the score of the class schedule constraint not being satisfied, from the total score. After the comparison is completed, the total score is displayed. The display module is configured to generate a graphical interface comprising a plurality of block units for display. According to the indices, the plurality of block units can correspond to the plurality of class messages, respectively, and the display module displays a class and a course title according to the identifier of the class message. The dragging module is configured to drag block unit. When the dragging module drags one of the block units, the dragging module defines the dragged block unit as a source block unit, and when the dragging action is stopped, the dragging module defines the block unit at the position where the dragging action is stopped, as a destination block unit, and the class schedule constraints are checked again whether the class schedule constraints are satisfied, so as to recalculate the total score for display. The processing module is configured to retrieve the class message corresponding to the source block unit as a source course, and compare the source course with the class messages corresponding to the plurality of block units one by one, so as to find out the block unit which is not allowed to exchange, according to the identifiers, indices and the class schedule constraints, and the processing module sets the found block unit with a collision flag and a collision description. When the destination block unit is not set with the collision flag and the dragging action is stopped, the processing module exchanges the class messages corresponding to the source block unit and the destination block unit. The prompting module is configured to highlight the block unit with the collision flag, and when the highlighted block unit corresponds to the destination block unit, the prompting module displays the collision description corresponding to the highlighted block unit.

Furthermore, the present invention provides a class timetable adjustment method with real-time feedback, and the method comprises steps of setting the class schedule constraints, wherein each class schedule constraint comprises class messages; in condition of the plurality of class schedule constraints, performing calculation according to a heuristic algorithm, to generate an initial class timetable, wherein the initial class timetable comprises class messages which each comprises an identifier and an index; checking whether the plurality of class schedule constraints are satisfied, and when one of the plurality of class schedule constraints is satisfied, accumulating the score of the class schedule constraint being satisfied, so as to generate a total score, and when one of the plurality of class schedule constraints is not satisfied, subtracting the score of the class schedule constraint not being satisfied, from the total score, and after the comparison is completed, displaying the total score; generating a graphical interface comprising a plurality of block units for display, wherein the plurality of block units correspond to the plurality of class messages according to the indices, respectively, and a class and a course title are displayed according to the identifier of the class message; in a condition that one of the plurality of block units is dragged, defining the dragged block unit as a source block unit, and when the dragging action is stopped, defining the block unit at the position where the dragging action is stopped, as a destination block unit, and checking again whether the plurality of class schedule constraints are satisfied, to recalculate the total score for display; retrieving the class message corresponding to the source block unit to serve as a source course, and comparing the source course with the class messages corresponding to the plurality of block units one by one, so as to find out the block unit which is not allowed to exchange, according to the identifiers, indices and the class schedule constraints, and setting the found block unit with a collision flag and a collision description, wherein when the destination block unit is not set with the collision flag and the dragging action is stopped, the class messages corresponding to the source block unit and the destination block unit are exchanged; highlighting the block unit set with the collision flag, and displaying the collision description corresponding to the highlighted block unit when the highlighted block unit corresponds to the destination block unit.

According to above content, the difference between the technology of the present invention and the conventional technology is that the system and the method of the present invention can perform calculation according to the heuristic algorithm in consideration of the class schedule constraints, to generate the initial class timetable comprising the class messages, and continuously check whether the class schedule constraints are satisfied, and calculate the total score according to the score of the check result, and generate the graphical interface comprising block units to display the initial class timetable; and, when one of the block unit is dragged, the system can find out the block unit not allowed to exchange according to the indices and the class schedule constraints, and set the found block unit with the collision flag and the collision description, so as to facilitate the user to adjust the total score in real-time during the class scheduling operation, and display and prompt certain block unit according to the collision description.

The technical solution of the present invention can achieve technical effect of improving appropriateness and convenience in class scheduling operation.

### BRIEF DESCRIPTION OF THE DRAWINGS

The structure, operating principle and effects of the present disclosure will be described in detail by way of various embodiments which are illustrated in the accompanying drawings.

FIG. 1 is a schematic view of a class timetable adjustment system, according to an embodiment of the present invention.

FIGS. 2A and 2B are flow charts of a class timetable adjustment method with real-time feedback, according to an embodiment of the present invention.

FIGS. 3A and 3B are flow charts of an operation of finding out the block unit not allowed to exchange, according to an embodiment of the present invention.

FIGS. 4A and 4B is schematic views of collision description and a total score after class timetable adjustment, according to an embodiment of the present invention.

FIG. 5 is a schematic view of an operation of setting the class schedule constraints and the score, according to an embodiment of the present invention.

### DETAILED DESCRIPTION OF THE PREFERRED EMBODIMENTS

The following embodiments of the present disclosure are herein described in detail with reference to the accompanying drawings. These drawings show specific examples of the embodiments of the present disclosure. It is to be understood that these embodiments are exemplary implementations and are not to be construed as limiting the scope of the present disclosure in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

The terms defined in the present invention are described before illustration of the class timetable adjustment system with real-time feedback and a method thereof of the present invention. The class schedule constraint of the present invention is a constraint which must be considered during class scheduling operation, and the class schedule constraint may be course, classroom, teacher, student, time slot, class schedule preference, and class collision list. The class scheduling problem has been proven to be an NP-complete problem, and the calculation result based on the class schedule constraints may just be a better solution, but not a best solution. In the present invention, each class schedule constraint can comprise a score, so that a total score of a class timetable can be increased when one of the class schedule constraints is satisfied, and the total score can be decreased when one of the class schedule constraints is not satisfied. The score of the class schedule constraint can be set according to a priority level of the class schedule constraint, for example, when the class schedule constraint has a higher priority level, the score of the class schedule constraint is also higher; and when the class schedule constraint has a lower priority level, the score of the class schedule constraint is also lower.

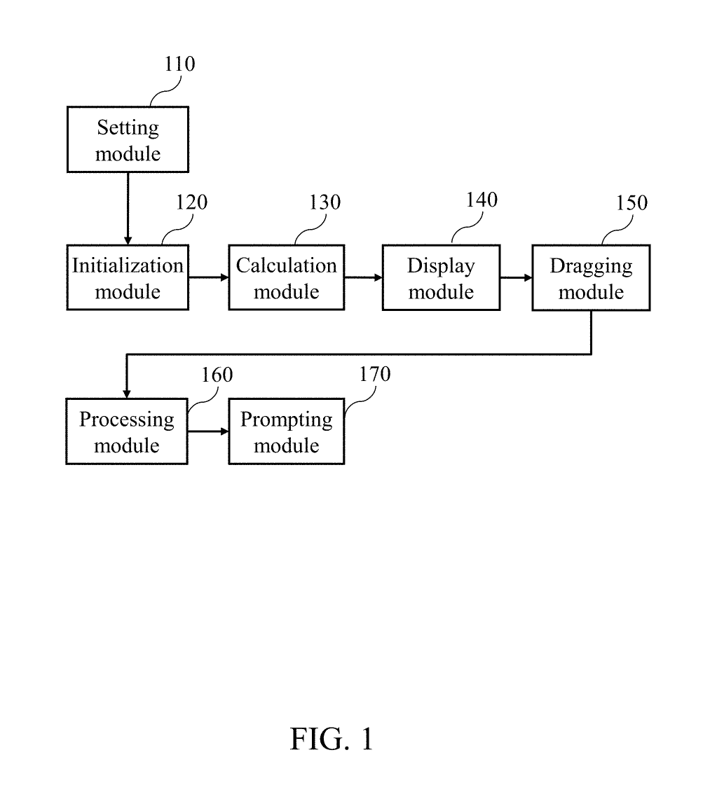

The following illustrates the class timetable adjustment system and the method thereof of the present invention with reference to drawings. Please refer to FIG. 1, which is a block diagram of a class timetable adjustment system with real-time feedback, according to an embodiment of the present invention. The system comprises a setting module 110, an initialization module 120, a calculation module 130, a display module 140, a dragging module 150, a processing module 160 and a prompting module 170. The setting module 110 is configured to set a plurality of class schedule constraints, and each class schedule constraint has a score. In actual implementation, the setting module 110 can generate a setting window to provide a user to set the class schedule constraints, and set the score of each class schedule constraint. The operation will be described with reference to the accompanying drawings, in following paragraphs.

The initialization module 120 is configured to perform calculation based on a heuristic algorithm in consideration of the class schedule constraints, to generate an initial class timetable. The initial class timetable comprises a plurality of class messages, and each class message comprises an identifier and an index. In actual implementation, the class scheduling problem has been proven to be a NP-complete problem, so that the heuristic algorithm such as Hill-Climbing Algorithm, Simulated Annealing Algorithm, Tabu Search Algorithm, Genetic Algorithm, Great Deluge Algorithm or Particle Swarm Optimization Algorithm, can be used to solve the class scheduling problem (NP-complete problem), thereby finding out an more appropriate class scheduling manner in consideration of the class schedule constraints, to generate the initial class timetable. It is to be noted that the generated initial class timetable comprises the plurality of class messages which each has the identifier and the index, and the identifier can include a class identifier, a classroom identifier, a teacher identifier, a subject identifier, and so on, and the index can include a time slot index, a date index, and so on. According to the identifier and index, it can know which class in which day is which course performed by which teacher in which classroom. For example, the date index can indicate which day, the time slot index can indicate which class, the teacher identifier can indicate which teacher, the classroom identifier can indicate which classroom, and the subject identifier can indicate which course. All of the aforementioned identifiers and indices can be regarded as a class integrally, and each class is assigned with the unique class identifier to distinguish from other classes. It is to be noted that when the initialization module 120 generates the initial class timetable, the initialization module 120 also generates a class collision list according to the identifiers and the indices of the class messages, and the generated class collision list can be used as the class schedule constraints, so as to prevent occurrence of class collision, for example, to prevent multiple courses from being arranged to the same time period for same grade and same class.

The calculation module 130 is configured to compare and check whether the class schedule constraints are satisfied. When one of the plurality of class schedule constraints is satisfied, the calculation module accumulates the score of the class schedule constraint being satisfied, so as to generate the total score; and when one of the class schedule constraints is not satisfied, the calculation module subtracts the score of the class schedule constraint not being satisfied, from the total score. After the comparison is completed, the total score is displayed. For example, suppose that the score of the first class schedule constraint is 10, and the score of the second class schedule constraint is 20, and when the first class schedule constraint is not satisfied and the second class schedule constraint is satisfied, the total score can be calculated by subtracting 10 and adding 20; in the other words, suppose that an original total score is 0, the total score becomes 10 after calculation, and the calculation formula is 0−10+20=10. According to the change in the total score after adjustment, the user can determine how many class schedule constraints are satisfied. In actual implementation, the score of the class schedule constraint can be determined according to the criticality of the class schedule constraint; for example, when the class schedule constraint has a higher criticality, the score of the class schedule constraint can be set to be higher; otherwise, when the class schedule constraint has a lower criticality, the score of the class schedule constraint can be set to be lower.

The display module 140 is configured to generate a graphic interface including block units. According to the index of the class message, each block unit can correspond to one of the plurality of class messages. The display module can display a class and a course title according to the identifier of the class message. In actual implementation, each block unit represents a time block and has the unique index to facilitate to correspond to the assigned block unit. The block units and the graphical interface will be described in detail in following paragraph, with reference to the accompanying drawings. It is to be noted that the different class messages for different grades or classes can be assigned with the same index, but different class messages for the same grade and the same class cannot be assigned the same index, because class collision can occur if multiple courses allocated in the same time period.

The dragging module 150 is configured to drag the block unit. When the dragging module is dragging one of the block units, the dragged block unit is defined as a source block unit, and when the dragging action is stopped, the dragging module defines the block unit at the position where the dragging action is stopped, as a destination block unit, and the dragging module compares and checks again whether the plurality of class schedule constraints are satisfied, so as to recalculate the total score for display. In actual implementation, the dragging action can be implemented by a cursor manner or a touch control manner. When the dragging action is stopped, it indicated the movement of the dragging action is stopped, but the dragging action is not terminated. In a case that the cursor manner is taken as example for illustration, the dragging action is to move a cursor to click a block unit under a condition that the user moves a mouse and keeps pressing a left button of the mouse, and when the user stops moving the mouse but keeps pressing the left button, it indicates the dragging action is stopped.

The processing module 160 is configured to retrieve the class message corresponding to the source block unit, and use the retrieved class message as a source class, and compare the source course with the class messages corresponding to the plurality of block units one by one, so as to find out the block unit which is not allowed to exchange, according to the identifiers, the indices and the class schedule constraints, and set the found block unit with a collision flag and a collision description. When the destination block unit is not set with the collision flag and the dragging action is stopped, the processing module 160 exchanges the class messages corresponding to the source block unit and the destination block unit. In actual implementation, the manner of finding out the block unit not allowed to exchange can includes following steps.

The first step is to determine whether the to-be-checked block unit is within lunch break time according to the index of the class message corresponding to the to-be-checked block unit, and if yes, the processing module 160 sets the to-be-checked block unit with the collision flag, and the collision description is embedded a description, such as a text “lunch break”.

The second step is to compare the source class and the class messages, one by one, so as to find the block units having the same course as the source class according to the identifier of the source class, and the processing module 160 sets the found block unit with the collision flag and collision description, such as a text “the exchange between the same course does not make sense”.

The third step is to find a time slot not allowed to arrange the source class in consideration of the class schedule constraints. The time slot not allowed to arrange certain class is presented by the index of the class message, to facilitate to find the corresponding block unit according to the index. For example, the index of the class message set as 102 indicates the second class on Monday, and the index corresponding to the block unit set as 504 indicates the fourth class on Friday. Similarly, the class message with the time index as 102 indicates the second class on Monday and corresponds to the block unit having this class message, and the class message with the time index as 504 indicates the fourth class on Friday and corresponds to the block unit having this class message. When the class schedule constraints include the course having the excluded time slot, the block unit corresponding to this course can be found according to the index of this course, and the found block unit are set with the collision flag and the collision description, such as a text “the course is not allowed to be allocated in this time slot”.

The fourth step is to find the class not allowed to exchange according to the class schedule constraints. For example, suppose that one of the class schedule constraints is a fixed list which records the course not allowed to adjusted, the block unit not allowed to exchange can be found according to the index of the class message recorded in the list, and the found block unit is set with the collision flag and the collision description, such as a text “the fixed course is not allowed to exchange”.

The fifth step is to find the block units which are not set with the collision flag and the collision description after above four steps, and compare and check these block units, respectively; and, the comparison and checking operation includes following operations. The first operation is to determine whether a current block unit has the class message corresponding thereto, and if yes, the corresponding course is defined as a target course. The second operation is to determine whether the index of the source course is within an excluded time slot of the target course, the time slot in which the target course cannot be allocated is presented by the index, and if yes, the processing module sets the current block unit with the collision flag and the collision description, such as a text “the target course cannot be allocated in the time slot of the source course”. The third operation is to retrieve the class message having the same index as the index of the current block unit, and then determine whether the teacher of the source course teaches at two places, and if yes, the current block unit is set with the collision flag and the collision description, such as a text “the teacher is unable to teach in two places at the same time”. According to the indices and a grade class timetable, the fourth operation is to check all courses arranged in the time slot of the source course, whether there is a course with the same teacher as the target course, and if yes, the current block unit is set with the collision flag and the collision description, such as a text “the teacher of the target course is assigned to other course in the time slot of the source course, so class collision occurs”. The fifth operation is to determine whether the class message corresponding to the current block unit is a specific course type, such as selectable course, and if no, the processing module checks next block unit; otherwise, if the class message corresponding to the current block unit is a specific course type, the processing module then checks whether all class messages of the current block unit exists in the class collision list of the source course, one by one; and, if yes, the processing module sets the current block unit with the collision flag and the collision description, such as a text “target course causes class collision”. The sixth operation is to retrieve, from the class collision list, all grade courses having the same index as the source block unit, and then check whether the current class message matches one of the retrieved grade course, and if yes, the current block unit is set with the collision flag and the collision description, such as a text “source course causes class collision”. The seventh operation is to determine whether there is a next block unit not checked yet, and if yes, the processing module checks the next block unit.

The prompting module 170 is configured to highlight the block unit set with the collision flag and the collision description. When the highlighted block unit corresponds to the destination block unit, the prompting module displays the collision description corresponding to the highlighted block unit. In actual implementation, the highlight manner comprises the manner of changing the background color (such as red), or flashing the text in the block unit or displaying the bold text in the block unit.

According to above descriptions, when the user wants to adjust the initial class timetable and uses cursor to drag a class in the class timetable, the user is to drag a block unit corresponding to the class, and at this time, this class is defined as the source course, and in consideration of the class schedule constraints, the system calculates and flags which block unit is not allowed to exchange with the dragged block unit, so as to highlight the block unit not allowed to exchange according to the flag. Next, when the dragged block unit is moved to the destination position, the block unit overlapped with the destination position is defined as the destination block unit, and the course corresponding to the destination block unit is defined as the target course, and the total score is recalculated for display. When the block unit overlapped with the destination position is not allowed to exchange, the collision description can also be displayed on the block unit. As a result, the user can know, in real time, the difference between the class timetables before adjustment and after adjustment, according to the total score and the collision description. It is appreciated that the user's dragging action is not terminated during aforementioned process, and the system can display which block unit is not allowed to exchange before the user exchanges the block unit actually, that is, during the process of dragging the block unit, the system can, in real time, display which block unit is not allowed to exchange, and then recalculate and display the total score when the block unit is dragged to the destination position, and when the block unit at the destination position is not allowed to exchange, the collision description corresponding to this block unit is also displayed to provide a class timetable adjustment reference for the user.

It is to be noted that in actual implementation, the setting module 110, the initialization module 120, the calculation module 130, the display module 140, the dragging module 150, the processing module 160 and the prompting module 170 included in the class timetable adjustment system of the present invention can be implemented by various manners including software, hardware or a combination thereof. For example, in an embodiment, each module can be implemented by software or hardware; furthermore, the system can be partially or fully implemented by hardware, for example, one or more module of the system can be implemented by IC chip, system on chip (SoC), complex programmable logic device (CPLD), field-programmable gate array (FPGA), and so on.

The technical solution provided by the present invention can be a system, a method and/or a computer program. The computer program may include a computer-readable storage medium carrying computer-readable program instructions executed by a processor to implement various aspects of the present invention. The computer-readable storage medium may be tangible equipment to hold and store instructions used by the instruction execution device. The computer-readable storage medium may be, but not limited to, an electronic storage device, a magnetic storage device, an optical storage device, an electromagnetic storage device, a semiconductor storage device, or a suitable combination thereof. More specific examples (non-exhaustive listings) of the computer-readable storage medium include hard disks, random access memory, read-only memory, flash memory, optical disks, floppy disks, and any suitable combination thereof. The computer-readable storage medium used herein is not to be interpreted as an instantaneous signal itself, such as a radio wave or other freely propagating electromagnetic wave, an electromagnetic wave propagating through a waveguide or other transmission medium (such as, an optical signal transmitted through a fiber optic cable), or electrical signal transmitted through a wire. Furthermore, the computer readable program instructions described herein may be downloaded from computer-readable storage medium to various computing/processing devices, or downloaded to an external computer device or external storage device over a network, such as Internet, a local area network, wide area network, and/or wireless network. The network may include copper transmission cables, fiber optic transmission cables, wireless transmissions, routers, firewalls, switches, hubs, and/or gateways. A network card or network interface in each computing/processing device can receive computer readable program instructions from the network, and forwards and stores the computer readable program instructions in the computer-readable storage medium in various computing/processing devices. The computer program instructions for performing the operations of the present invention may include assembly language instructions, instruction-set-architecture instructions, machine instructions, machine-related instructions, micro instructions, firmware instructions, or source code or object code written in one programming language or any combination of at least two programming language. The programming language includes object-oriented programming language such as Common Lisp, Python, C+ Objective-C, Smalltalk, Delphi, Java, Swift, C#, Perl, Ruby, PHP, and so on; and Procedural programming language, such as C or similar programming language. The computer readable program instructions may be executed entirely on a computer, partially on a computer, or, executed as a stand-alone software, or executed partly on a client computer and on a remote computer, or, executed entirely on a remote computer or server.

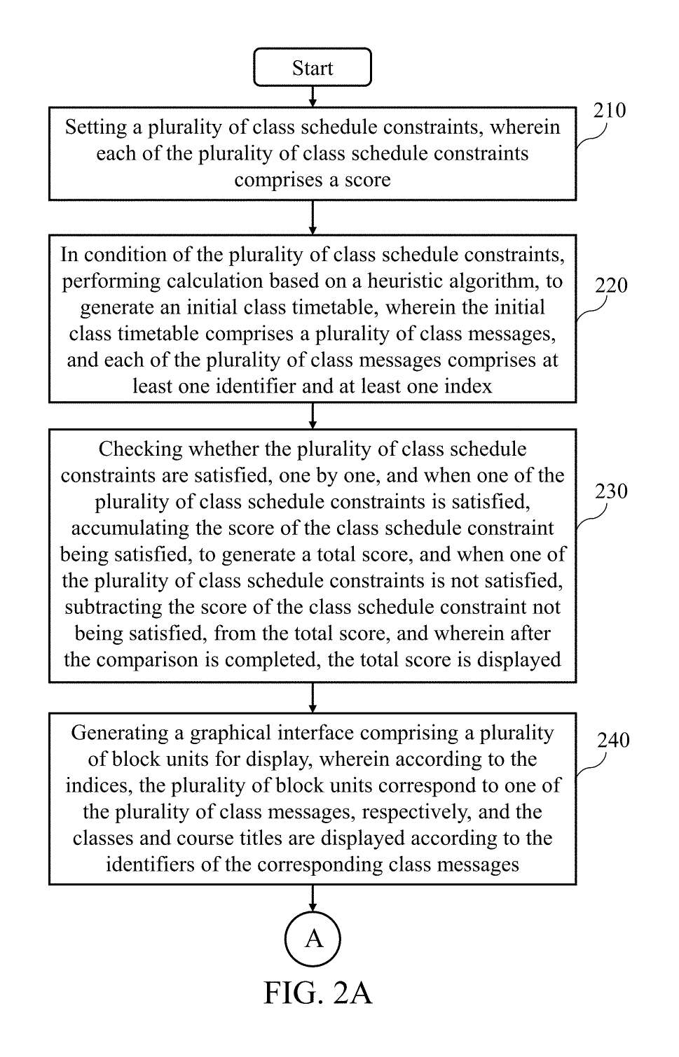

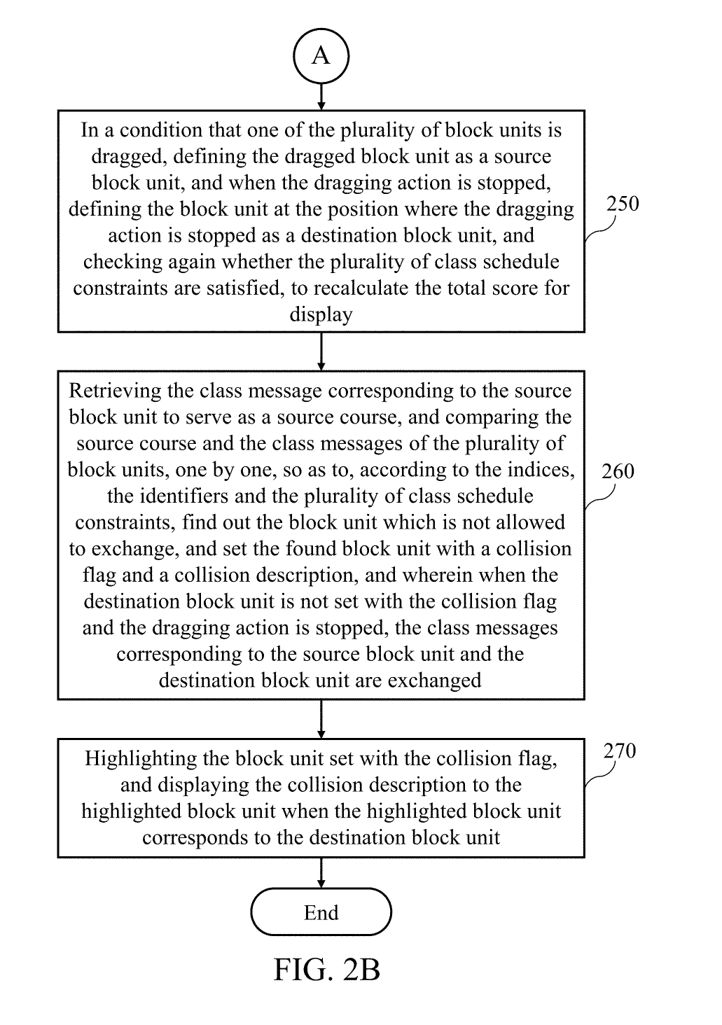

Please refer to FIGS. 2A and 2B, which are flow charts of class timetable adjustment method with real-time feedback, according to an embodiment of the present invention. The method comprises steps 210 to 270. In the step 210, the class schedule constraints are set, and each class schedule constraint comprises a class messages. In the step 220, in condition of the plurality of class schedule constraints, the solution calculation is performed according to a heuristic algorithm, to generate an initial class timetable. The initial class timetable comprises class messages, and each class message comprises an identifier and an index. In the step 230, it is checked whether the plurality of class schedule constraints are satisfied, and when one of the plurality of class schedule constraints is satisfied, the score of the class schedule constraint being satisfied is accumulated to generate a total score; and, when one of the plurality of class schedule constraints is not satisfied, the score of the class schedule constraint not being satisfied is subtracted from the total score, and after the comparison is completed, the total score is displayed. In the step 240, a graphical interface comprising a plurality of block units for display is generated. According to the indices, the plurality of block units can correspond to the plurality of class messages, respectively, and the display module displays a class and a course title according to the identifier of the class message. In the step 250, when one of the plurality of block units is dragged, the dragged block unit is defined as a source block unit, and when the dragging action is stopped, the block unit at the position where the dragging action is stopped, is defined as a destination block unit, and the plurality of class schedule constraints are checked whether they are satisfied again, so as to recalculate the total score for display. In the step 260, the class message corresponding to the source block unit is retrieved to serve as a source course, and the source course is compared with the class messages corresponding to the plurality of block units, one by one, so as to find out the block unit which is not allowed to exchange, according to the identifiers, indices and the class schedule constraints, and then the found block unit is set with the collision flag and the collision description; and when the destination block unit is not set with the collision flag and the dragging action is stopped, the class messages corresponding to the source block unit and the destination block unit are exchanged. In the step 270, the block unit set with the collision flag is highlighted, and when the highlighted block unit corresponds to the destination block unit, the prompting module displays the collision description corresponding to the highlighted block unit. Through aforementioned steps, in consideration of class schedule constraints, the class timetable adjustment method of the present invention can perform calculation according to the heuristic algorithm to generate the initial class timetable comprising class messages, and continuously check whether the class schedule constraints are satisfied, and calculate the total score according to the score of the check result, and generate the graphical interface comprising block units to display the initial class timetable, and when one of the block unit is dragged, the block unit not allowed to exchange can be found according to the identifiers, the indices and the class schedule constraints, and the found block unit is set with the collision flag and the collision description. As a result, the method of the present invention can facilitate the user to adjust the total score, and display and prompt the block units to the user according to the collision description in real-time during the class scheduling operation

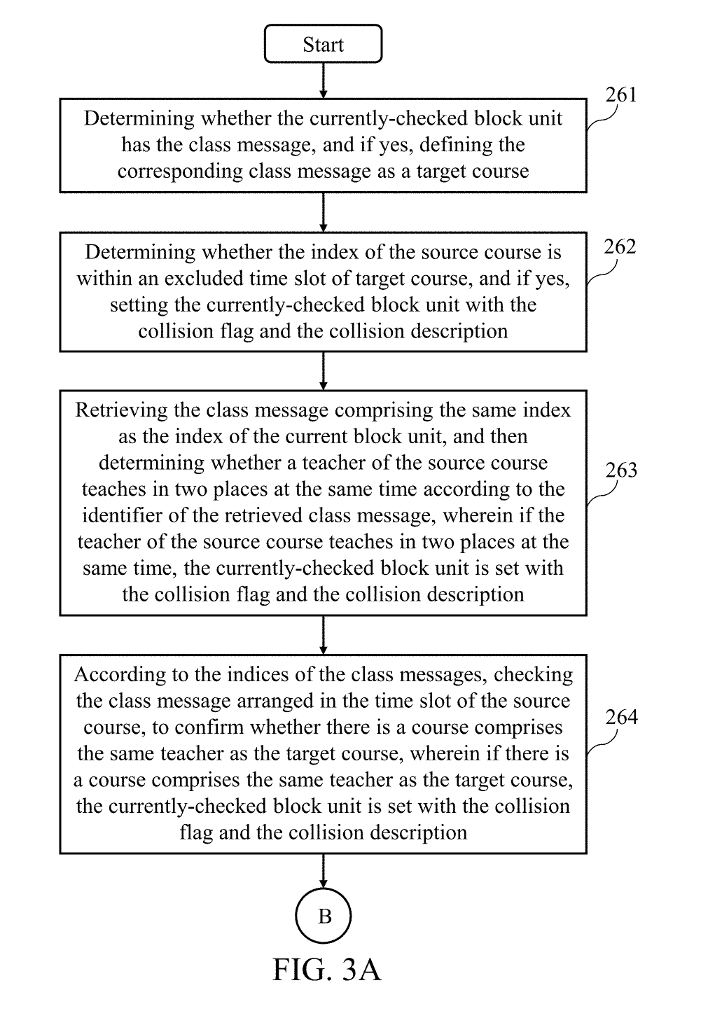

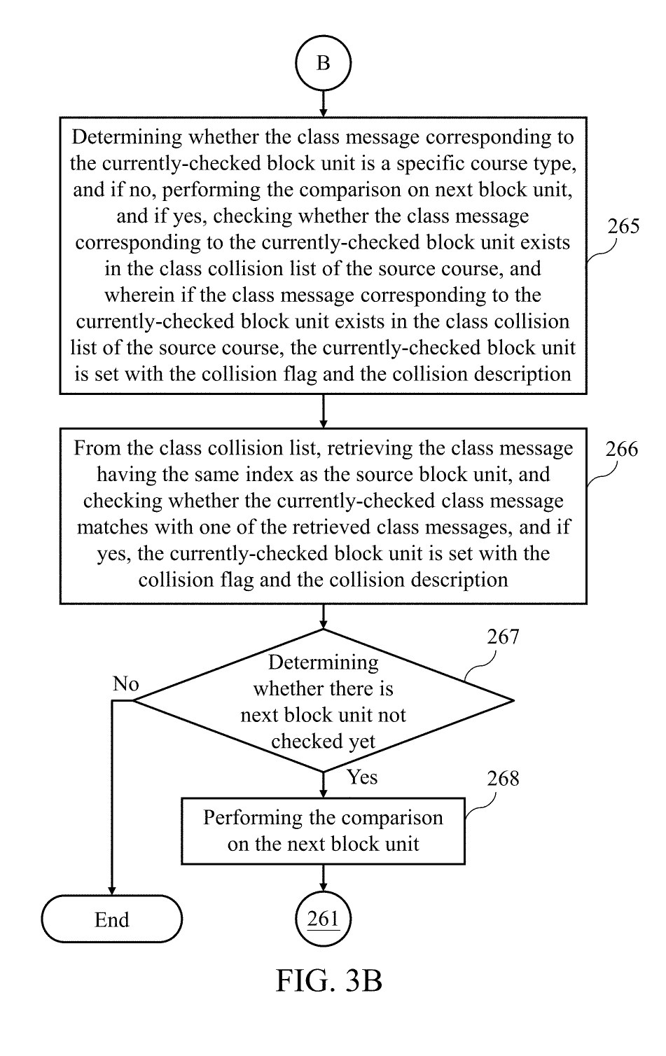

The following is to describe an embodiment of the present invention in reference with FIGS. 3A to 5. Please refer to FIGS. 3A and 3B, which are flow charts of an operation of finding out the block unit not allowed to exchange, according to an embodiment of the present invention. In actual implementation, the operation of finding the block unit not allowed to exchange can be divided into two stages. The first stage is to find a condition that the source block unit cannot be changed to the destination block unit, for example, the source block unit cannot be changed to the lunch break time, the same course, the excluded time slot, and the fixed course and so on. The second stage is to find a condition that the destination block unit cannot be changed to the source block unit, for example, the condition that the destination block unit cannot be changed to the excluded time, the teacher cannot teach in two places at the same time, or class collision occurs. The block units found in the first stage are set with the collision flag and the collision description. In the second stage, the block units not set with the collision flag in the first stage are checked one by one, and the checking operation in the second stage can include steps 261 to 268. In the step 261, it is to determine whether the current block unit has the class message corresponding thereto, and if yes, the corresponding course is defined as a target course. In the step 262, it is to determine whether the index of the source course is within an excluded time slot of the target course, and if yes, the current block unit is set with the collision flag and the collision description. In the step 263, it is to retrieve the class message having the same index as the index of the current block unit, and determine whether the teacher of the source course teaches at two places at the same time, and if yes, the current block unit is set with the collision flag and the collision description. In the step 264, according to the indices, it is to check all courses arranged in the time slot of the source course, from the grade class timetable, whether there is a course with the same teacher as the target course, and if yes, the current block unit is set with the collision flag and the collision description. In the step 265, it is to determine whether the class message corresponding to the current block unit is a specific course type, and if no, next block unit is checked; otherwise, if the class message corresponding to the current block unit is a specific course type, it is to check whether the class messages of the current block unit exists in the class collision list of the source course, one by one, and if at least one of the class messages of the current block unit exists in the class collision list of the source course, the current block unit is set with the collision flag and the collision description. In the step 266, from the class collision list, it is to retrieve all grade courses having the same index as the source block unit, and also check whether the current class message matches one of the retrieved grade course, and if yes, the current block unit is set with the collision flag and the collision description. In the step 267, it is to determine whether there is next block unit not checked yet. In the step 268, when it is determined, in the step 267, that there is block unit not checked yet, the steps 261 to 267 are repeated to check the next block unit. When all block units are checked already, the checking operation is completed.

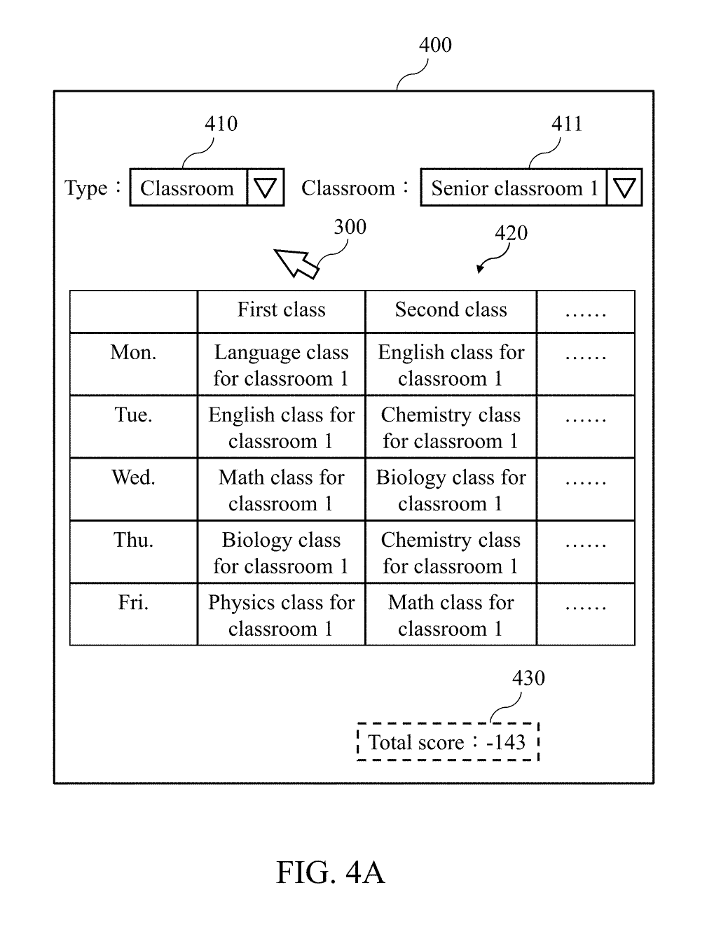

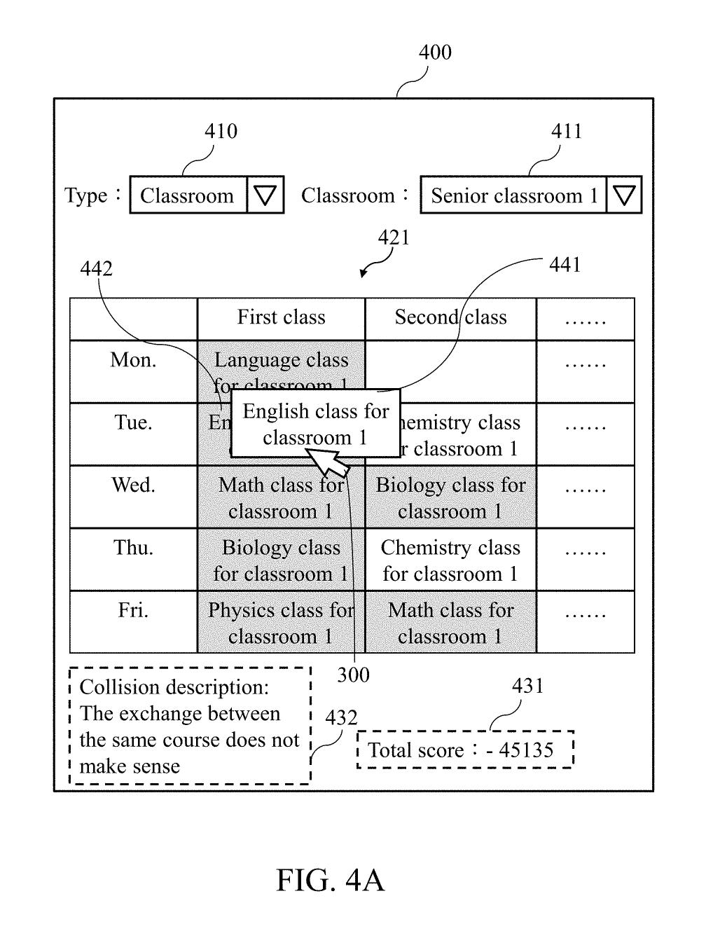

Please refer to FIGS. 4A and 4B, which are schematic views of the display block unit, the collision description, and the total score when the class timetable is adjusted, according to an embodiment of the present invention. Please refer to FIG. 4A. After the initial module 120 generates the initial class schedule including class message according to the class schedule constraints, when the user opens the webpage 400 through a browser, the display module 140 generates the graphical interface 420 including the multiple block units, and displays the corresponding classes and course names on the block units according to the initial class schedule. In practical implementation, the user can set filter conditions by operating a type selection component 410 and a classroom selection component 411, so as to load and display the initial class timetable corresponding to the filter conditions, on the graphical interfaces 420. In addition, the calculation module 130 can check, one by one, whether the class schedule constraints are satisfied, and when one of the class schedule constraints is satisfied, the corresponding score are accumulated to generate the total score. When one of the class schedule constraints is not satisfied, the total score is subtracted by the score of the class schedule constraint not being satisfied. After the comparisons are completed, the calculated total score is displayed in the total score display block 430, as shown in FIG. 4A.

Next, when the user wants to adjust the class timetable, the user can operate a cursor 300 to click the block unit to be adjusted (or, this block unit can be called as a source block unit 441) and drag the clicked block unit to the block unit to be replaced (or, the to-be-replaced block unit is also called as a destination block unit 442). When the user drags the source block unit 441, the processing module 160 retrieves the class message corresponding to the source block unit 441 as a source course, and compares the source course with the class messages corresponding to all block units one by one, so as to find out the block unit that is not allowed to exchange, according to the identifiers, the indices, and the class schedule constraints, and to set the collision flag and the collision description in the block units not allowed to exchange. Then, the prompting module 170 highlights the block unit set with the collision flag, such as the gray block unit in the graphic interface 421 illustrated in FIG. 4B. When the destination block unit 442 is set with the collision flag, the prompting module 170 displays the collision description in the conflict description block 432 at the same time, such as a text “The exchange between the same courses does not make sense”. In addition, when the destination block unit is not set with the collision flag, after the dragging operation is completely, the processing module 160 exchanges the class messages corresponding to the source block unit and the destination block unit, for example, the indices or the identifiers are exchanged to make the courses displayed on the source block unit and the destination block unit are exchanged at the same time.

It is to be noted that when the user drags the source block unit 441 to the destination block unit 442, the calculation module 130 can re-calculate the total score according to whether the class schedule constraints are satisfied, and the recalculated total score is displayed on the total score display block 431, as shown in FIG. 4B. In this way, the user can know the reasons of the classes not allowed to exchange, according to the collision description displayed in the collision description block 432, and also can quickly and correctly perform class scheduling operation according to the new total score, after adjustment, displayed in the total score display block 431; in the other words, when the total score becomes lower, it indicates that the class scheduling result is worse after adjustment, and when the total score becomes higher, the class scheduling result is better. As a result, the class timetable adjustment system can prevent the user from arranging the class timetable with class collision.

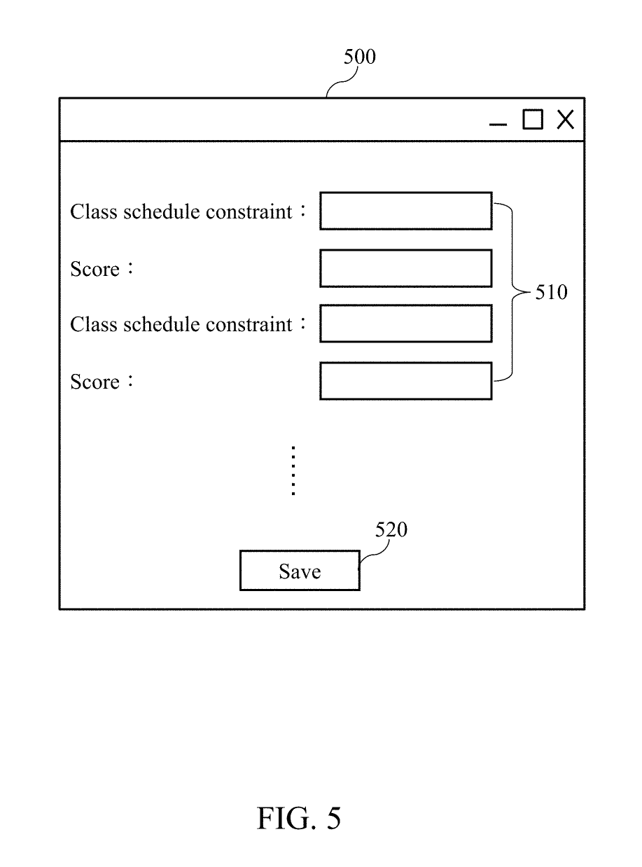

As shown in FIG. 5, which is a schematic view of operations of setting the class schedule constraints and the score, according to an embodiment of the present invention. In actual implementation, the setting module 110 may generate a setting window 500 for the user to set the class schedule constraints and its corresponding score in input blocks 510, and the user can click a saving component 520 to complete the setting operation. For example, when the user wants to set excluded time slots for a course (such as, physics course, whose course ID is “0001”), and the excluded time slot is represented by an index, for example, the index “101” represents the first class on Monday, and the index “306” represents the sixth class on Wednesday. The user can input “nalist:0001;101,306” into the input block 510 to set a class constraint. The term “nalist” represents the type of the inputted class schedule constraint, that is, the excluded time. In addition, when the user wants to set a dedicated classroom (for example, the classroom identifier is “S001”) to only arrange chemistry classes (the course identifier is “0002”), the user can input “prolist:S001;0002” in the input block 510, to set a class schedule constraint. The term “prolist” represents the type of the inputted class schedule constraint, that is, dedicated classroom and the course corresponding thereto. Above-mentioned content is described for exemplary illustration of operation of setting the class schedule constraints, but the present invention is not limited thereto, and any format and code that can be used to set the class schedule constraints are not departed from the scope of the present invention. For example, the index can be changed to two independent indices including a time index and a date index, and the time index is used to specify which class in the day, and the date index is used to specify which day in the week. In this way, the user can use the date index value to quickly set a condition that which day is unable to be scheduled for the class in a week. For example, Monday is the day of teaching research in biology and the biology teacher must meet for a meeting, so the biology class cannot be arranged in all day on Monday.

In summary, the difference between the technology of the present invention and the conventional technology is that the system and the method of the present invention can perform calculation to generate the initial class timetable including the class messages, and continuously check whether the class schedule constraints are satisfied, and calculate the total score according to the score of the check result, and generate the graphical interface comprising block units to display the initial class timetable, and when one of the block units is dragged, the system and method can find out the block unit not allowed to exchange according to the identifiers, the indices and the class schedule constraints, and set the found block unit with the collision flag and the collision description, so as to facilitate the user to adjust the total score in real-time during the class scheduling operation, and can change the display manner of the block unit to prompt the user according to the collision description. As a result, the technical solution of the present invention can solve the conventional problem, and achieve technical effect of improving appropriateness and convenience in class scheduling.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A class timetable adjustment system with real-time feedback, comprising,
a setting module configured to set a plurality of class schedule constraints, and each of the plurality of class schedule constraints comprising a score;
an initialization module configured to generate an initial class timetable based on a heuristic algorithm, in consideration of the class schedule constraints, and wherein the initial class timetable comprises a plurality of class messages, and each of the class messages comprises at least one identifier and at least one index;
a calculation module configured to check, one by one, whether the plurality of class schedule constraints are satisfied, wherein when one of the plurality of class schedule constraints is satisfied, the calculation module accumulates the score of the class schedule constraint being satisfied, so as to generate a total score, and when one of the plurality of class schedule constraints is not satisfied, the calculation module subtracts the score of the class schedule constraint not being satisfied, from the total score, and after the comparison is completed, the total score is displayed;
a display module configured to generate a graphical interface comprising a plurality of block units for display, wherein the plurality of block units correspond to the plurality of class messages, respectively, according to the indices, and the display module displays a class and a course title according to the identifier of the class message;
a dragging module configured to drag one of the plurality of block units, wherein the dragging module defines the dragged block unit as a source block unit, and when the dragging action is stopped, the dragging module defines the block unit at the position where the dragging action is stopped, as a destination block unit, and the plurality of class schedule constraints are checked, again, whether the plurality of class schedule constraints are satisfied, so as to recalculate the total score for display;
a processing module configured to retrieve the class message corresponding to the source block unit as a source course, and compare the source course with the class messages of corresponding to the plurality of block units, one by one, so as to, according to the identifier, index and the class schedule constraint, find out the block unit which is not allowed to exchange, and set the found block unit with a collision flag and a collision description, and when the destination block unit is not set with the collision flag and the dragging action is stopped, the processing module exchanges the class messages corresponding to the source block unit and the destination block unit; and
a prompting module configured to highlight the block unit set with the collision flag, and when the highlighted block unit corresponds to the destination block unit, the prompting module displays the collision description corresponding to the highlighted block unit.

2. The class timetable adjustment system according to claim 1, wherein when the initialization module generates the initial class timetable, the initialization module generates a class collision list according to the identifiers and the indices of the plurality of class messages, and use the generated class collision list as the plurality of class schedule constraints.

3. The class timetable adjustment system according to claim 2, wherein when the processing module compares the class messages corresponding to the source course and the plurality of block units, one by one, the processing module is configured to:
determine whether a currently-checked block unit has the class message corresponding thereto, and if yes, the processing module defines the corresponding class message as a target course;
determine whether the index of the source course is within an excluded time slot of the target course, and if yes, the processing module sets the currently-checked block unit with the collision flag and the collision description;
retrieve the class message comprising the same index as the index of the currently-checked block unit, and according to the identifier, determine whether the teacher of the source course teaches in two places at the same time, and if yes, the processing module sets the current block unit with the collision flag and the collision description;
according to the indices, check the class messages arranged in the time slots of the source course, so as to check whether there is a course with the same teacher as the target course, if yes, set the current block unit with the collision flag and the collision description;
determine whether the class message corresponding to the current block unit is a specific course type, and if no, the processing module performs comparison on a next block unit, and if yes, the processing module checks whether all class messages of the currently-checked block unit exists in the class collision list of the source course, one by one, and wherein if at least one of the class messages of the currently-checked block unit exists in the class collision list of the source course, the processing module sets the currently-checked block unit with the collision flag and the collision description;
from the class collision list, retrieve all class messages having the same indices as the source block unit, and check whether the class message of the currently-checked block unit matches with one of the retrieved class messages, and if yes, the processing module sets the currently-checked block unit with the collision flag and the collision description; and
determine whether there is a next block unit not checked yet, and if yes, the processing module performs comparison on the next block unit.

4. The class timetable adjustment system according to claim 1, wherein when the processing module exchanges the class messages corresponding to the source block unit and the destination block unit, the processing module is configured to exchange the indices, the identifiers, or, the indices and the identifiers of the class messages.

5. The class timetable adjustment system according to claim 1, wherein the heuristic algorithm is Hill-Climbing Algorithm, Simulated Annealing Algorithm, Tabu Search Algorithm, Genetic Algorithm, Great Deluge Algorithm or Particle Swarm Optimization Algorithm.

6. A class timetable adjustment method with real-time feedback, comprising:
setting a plurality of class schedule constraints, wherein each of the plurality of class schedule constraints comprises a score;
in condition of the plurality of class schedule constraints, performing calculation based on a heuristic algorithm, to generate an initial class timetable, wherein the initial class timetable comprises a plurality of class messages, and each of the plurality of class messages comprises at least one identifier and at least one index;
checking whether the plurality of class schedule constraints are satisfied, one by one, and when one of the plurality of class schedule constraints is satisfied, accumulating the score of the class schedule constraint being satisfied, to generate a total score, and when one of the plurality of class schedule constraints is not satisfied, subtracting the score of the class schedule constraint not being satisfied, from the total score, and wherein after the comparison is completed, the total score is displayed;
generating a graphical interface comprising a plurality of block units for display, wherein according to the indices, the plurality of block units correspond to one of the plurality of class messages, respectively, and the classes and course titles are displayed according to the identifiers of the corresponding class messages;
in a condition that one of the plurality of block units is dragged, defining the dragged block unit as a source block unit, and when the dragging action is stopped, defining the block unit at the position where the dragging action is stopped as a destination block unit, and checking again whether the plurality of class schedule constraints are satisfied, to recalculate the total score for display;
retrieving the class message corresponding to the source block unit to serve as a source course, and comparing the source course and the class messages of the plurality of block units, one by one, so as to, according to the indices, the identifiers and the plurality of class schedule constraints, find out the block unit which is not allowed to exchange, and set the found block unit with a collision flag and a collision description, and wherein when the destination block unit is not set with the collision flag and the dragging action is stopped, the class messages corresponding to the source block unit and the destination block unit are exchanged; and
highlighting the block unit set with the collision flag, and displaying the collision description to the highlighted block unit when the highlighted block unit corresponds to the destination block unit.

7. The class timetable adjustment method according to claim 6, wherein the step of generating the initial class timetable, further comprises:
according to the identifiers and the indices of the class messages, generating a class collision list, and defining the class collision list as the plurality of class schedule constraints.

8. The class timetable adjustment method according to claim 7, wherein the step of comparing the source course and the class messages of the plurality of block units, one by one, further comprises:
determining whether the currently-checked block unit has the class message, and if yes, defining the corresponding class message as a target course;
determining whether the index of the source course is within an excluded time slot of target course, and if yes, setting the currently-checked block unit with the collision flag and the collision description;
retrieving the class message comprising the same index as the index of the current block unit, and then determining whether a teacher of the source course teaches in two places at the same time according to the identifier of the retrieved class message, wherein if the teacher of the source course teaches in two places at the same time, the currently-checked block unit is set with the collision flag and the collision description;
according to the indices of the class messages, checking the class message arranged in the time slot of the source course, to confirm whether there is a course comprises the same teacher as the target course, wherein if there is a course comprises the same teacher as the target course, the currently-checked block unit is set with the collision flag and the collision description;
determining whether the class message corresponding to the currently-checked block unit is a specific course type, and if no, performing the comparison on next block unit, and if yes, checking whether the class message corresponding to the currently-checked block unit exists in the class collision list of the source course, and wherein if the class message corresponding to the currently-checked block unit exists in the class collision list of the source course, the currently-checked block unit is set with the collision flag and the collision description;
from the class collision list, retrieving the class message having the same index as the source block unit, and checking whether the currently-checked class message matches with one of the retrieved class messages, and if yes, the currently-checked block unit is set with the collision flag and the collision description; and
determining whether there is next block unit not checked yet, and if yes, performing the comparison on the next block unit.

9. The class timetable adjustment method according to claim 6, wherein the step of exchanging the class messages corresponding to the source block unit and the destination block unit, further comprises:
exchanging the indices, the identifiers, or, the indices and the identifiers of the class messages.

10. The class timetable adjustment method according to claim 6, wherein the heuristic algorithm is Hill-Climbing Algorithm, Simulated Annealing Algorithm, Tabu Search Algorithm, Genetic Algorithm, Great Deluge Algorithm or Particle Swarm Optimization Algorithm.
